(19) United States
(12) Patent Application Publication
(10) Pub. No.: US 2025/0199862 A1
(43) Pub. Date: Jun. 19, 2025

(54) CONTROL APPARATUS, CONTROL METHOD, AND NON-TRANSITORY COMPUTER-READABLE MEDIUM

(71) Applicant: NEC Corporation, Minato-ku, Tokyo (JP)

(72) Inventor: Yousuke SHINKE, Tokyo (JP)

(73) Assignee: NEC Corporation, Minato-ku, Tokyo (JP)

(21) Appl. No.: 18/848,242

(22) PCT Filed: Mar. 28, 2022
(86) PCT No.: PCT/JP2022/014854

§ 371 Date: Sep. 18, 2024

(51) Int. Cl. G06F 9/50; H04W 4/021

(52) U.S. Cl. CPC G06F 9/5027; H04W 4/021; G06F 2209/505

(57) ABSTRACT

A control apparatus predicts, for a target service to be provided at a service provision location, the number of users of the target service, before the provision starts. The control apparatus performs control regarding an instance of an application that provides the target service, or control of a service chaining among a plurality of the applications, based on the predicted number of users.

### TECHNICAL FIELD

The present disclosure relates to a technique for preventing a delay in a service.

### BACKGROUND ART

Service provision via a network has been carried out. Patent Literature 1 discloses that service requests are distributed among service nodes in accordance with a service policy. In addition, as one method of load balancing, scale-out of a virtual machine or the like according to a service load is disclosed.

### CITATION LIST

### Patent Literature

Patent Literature 1: Japanese Unexamined Patent Application Publication No. 2017-118575

### SUMMARY OF INVENTION

### Technical Problem

In scale-out according to a service load, increase in the service load is dealt with afterwards. Therefore, it is considered that a service delay occurs for a while after the increase in the service load. The present invention has been made in view of such a problem, and one objective thereof is to provide a novel technique for preventing a delay in a service.

### Solution to Problem

A control apparatus according to the present disclosure includes: a prediction unit configured to predict the number of users of a service to be provided at a specific location, before the provision of the service starts; and a control unit configured to perform control regarding an instance of an application providing the service, or control for a service chaining among a plurality of the applications, based on the predicted number of users.

A control method according to the present disclosure is executed by a computer. The control method includes: a prediction step of predicting the number of users of a service to be provided at a specific location, before the provision of the service starts; and a control step of performing control regarding an instance of an application providing the service or control for a service chaining among a plurality of the applications, based on the predicted number of users.

A non-transitory computer-readable medium according to the present disclosure stores a program for causing a computer to execute the control method according to the present disclosure.

### Advantageous Effects of Invention

According to the present disclosure, a novel technique for preventing a delay in a service is provided.

### BRIEF DESCRIPTION OF DRAWINGS

FIG. 1 is a diagram illustrating an overview of an operation of a control apparatus according to a first example embodiment;

FIG. 2 is a block diagram illustrating a functional configuration of the control apparatus according to the first example embodiment;

FIG. 3 is a block diagram illustrating a hardware configuration of a computer that implements a control apparatus;

FIG. 4 is a flowchart illustrating a flow of processing executed by the control apparatus according to the first example embodiment;

FIG. 5 is a diagram illustrating information in which the predicted number of users is associated with the necessary number of instances; and

FIG. 6 is a diagram illustrating a plurality of clusters provided at locations apart from one another.

### EXAMPLE EMBODIMENT

Hereinafter, example embodiments of the present disclosure is described in detail with reference to the drawings. In the drawings, the same or corresponding element is denoted by the same reference sign, and redundant descriptions are omitted as necessary for clarity of description. Further, unless otherwise described, values set in advance such as a predetermined value and a reference value are stored in advance in any storage unit in such a manner as to be accessible from an apparatus using the value. Further, unless otherwise specified, the storage unit is constituted by one or more numbers of storage apparatuses.

### First Example Embodiment

### <Overview>

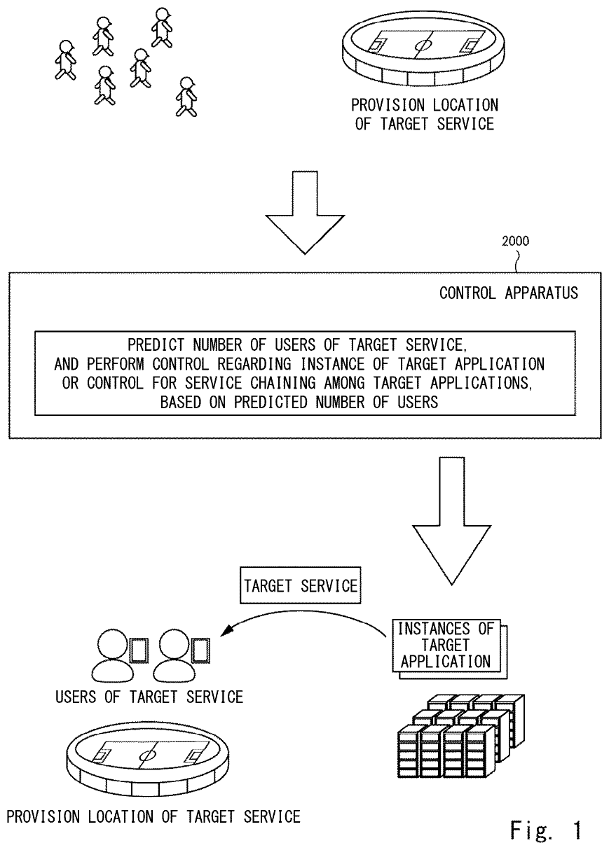

FIG. 1 is a diagram illustrating an overview of an operation of a control apparatus 2000 according to a first example embodiment. Herein, FIG. 1 is a diagram for facilitating understanding of the overview of the control apparatus 2000, and the operation of the control apparatus 2000 is not limited to that illustrated in FIG. 1.

The control apparatus 2000 performs control regarding an instance of an application being used for providing a service, or control for a service chaining among applications, before provision of the service starts. Herein, the application is software that performs some or all of the processes necessary for providing a service. Hereinafter, an application to be controlled by the control apparatus 2000 is referred to as a target application. A service provided by using the target application is referred to as a target service.

One or more instances of the target application are being used to provide the target service. Herein, the target application being used for providing the target service may be one type or may be a plurality of types. In the former case, one or more instances of one type of target application are generated. In the latter case, one or more instances are generated for each of the plurality of types of target applications. Then, the target service is achieved by cooperation of a plurality of types of target applications.

The target service is provided at a specific location. The provision location of the target service is, for example, an event venue in which an event related to the target service is performed. For example, it is assumed that in a stadium where sports games are held, a video viewing service that provides videos of games taken from various angles is provided. By using the video viewing service, a person watching the game at the stadium can enjoy the game more by using the video viewing service on his or her mobile terminal while watching the game live from the audience seat. In such a situation, the target service is the video viewing service, the service provision location is the stadium, and the user of the target service is some or all of the audiences of the game.

Similar video viewing services may also be provided at public viewing venues. At the public viewing venue, a relay video of the game is replayed on a large display that can be viewed by many participants. At this time, the above-described video viewing service is provided to the participant of the public viewing. The participant can enjoy the game more by using the video viewing service on his or her mobile terminal while watching the video of the game on the large display. In such a situation, the target service is the video viewing service, the service provision location is the public viewing venue, and the user of the target service is some or all of the participants of the public viewing.

In the above-described system for providing a video viewing service, an encoding server, a processing server, a distribution server, or the like may be used. The encoding server encodes video data generated by a camera into a format suitable for distribution. The processing server performs a process of adding a ticker to the video data, a process of converting the video data into a data focused on a specific person, and the like. The distribution server distributes the processed video data to a user terminal.

Thus, for example, in the control apparatus 2000, each software that implements the functions of these servers is treated as a target application. In addition, an instance such as a virtual machine that implements these servers is treated as an instance of the target application.

In addition, there may be cases where it is preferable to set up a security-virtual network function (VNF) between the servers and the user terminal. Therefore, such a security VNF may be treated as a target application. In such a case, an instance such as a virtual machine that implements security VNF is treated as an instance of the target application. Note that the VNF that may be treated as the target application is not limited to the security VNF, and any type of VNF can be treated as the target application.

The control apparatus 2000 predicts the number of users of the target service, and performs control regarding the instance of the target application or control for a service chaining among plurality of target applications, according to the number of users that has been predicted (hereinafter, the predicted number of users). The control regarding the instance of the target application includes, for example, control of the number of instances and control of computer resources being allocated to the instances.

In the above-described example of the video viewing service, the distribution server or the processing server may be increased or decreased, or the arrangement thereof may be changed, according to the increase or the decrease of the users. In addition, the security VNF may be increased or decreased, or the arrangement thereof may be changed, according to the increase, the decrease, or the change of arrangement of the distribution server or the processing server. The service chaining is performed in such a way that these dynamically increasing or decreasing target applications are appropriately cooperated with each other on the network.

### An Example of Advantageous Effect

According to the control apparatus 2000 of the present example embodiment, the number of users of the target service is predicted before the provision of the target service is started, and control regarding an instance of the target application or control for a service chaining among the target applications is performed based on the predicted number of users. Accordingly, it is possible to appropriately control an application being used for providing the target service, before the provision of the target service is started.

For example, it is assumed that such control is not performed before the target service is provided, and such control is performed only after the provision of the target service is started. In such a case, an actual load on the target service is dealt with afterwards. Therefore, there is a possibility that the provision of the target service cannot be appropriately performed, such as an occurrence of a large delay for a while after the provision of the target service is started. Further, in a case where the number of users of the target service continues to increase, a situation in which a delay occurs may continue. Therefore, the convenience of the target service is reduced. Further, a required quality of service cannot be satisfied for a service requiring low delay.

In this regard, according to the control apparatus 2000 of the present example embodiment, the control regarding the target application is appropriately performed before the provision of the target service is started. Therefore, it is possible to appropriately provide the target service from the time when the provision of the target service is started. Therefore, the convenience of the target service can be kept high. Also, the required quality of service can be satisfied for a service that requires low delay.

Hereinafter, the control apparatus 2000 according to the present example embodiment is described in more detail.

### Example of Functional Configuration

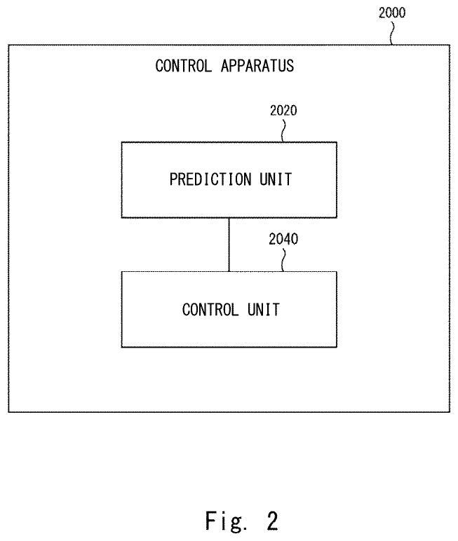

FIG. 2 is a block diagram illustrating a functional configuration of the control apparatus 2000 according to the first example embodiment. The control apparatus 2000 includes a prediction unit 2020 and a control unit 2040. The prediction unit 2020 predicts the number of users of the target service before the provision of the target service is started. The control unit 2040 performs control regarding the instance of the target application or control for the service chaining among the target applications, based on the predicted number of users of the target service.

### Example of Hardware Configuration

Each functional component of the control apparatus 2000 may be implemented by hardware (e.g., a hardwired electronic circuit) that implements each functional component, or may be implemented by a combination of hardware and software (e.g., a combination of an electronic circuit and a program that controls the electronic circuit). Hereinafter, a case where each functional component of the control apparatus 2000 is implemented by a combination of hardware and software is further described.

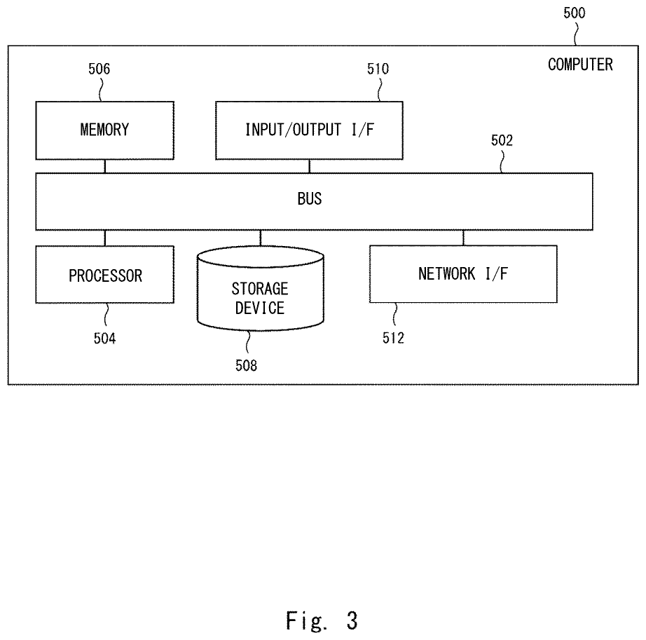

FIG. 3 is a block diagram illustrating a hardware configuration of a computer 500 that implements the control apparatus 2000. The computer 500 is any kind of computer. For example, the computer 500 is a stationary computer such as a personal computer (PC) or a server machine. Further, for example, the computer 500 is a portable computer such as a smartphone or a tablet terminal. The computer 500 may be a dedicated computer designed to implement the control apparatus 2000, or may be a general-purpose computer.

For example, by installing a predetermined application on the computer 500, each function of the control apparatus 2000 is implemented by the computer 500. The application is configured by a program for implementing each functional component of the control apparatus 2000. Note that the program may be acquired by any method. For example, the program can be acquired from a storage medium (such as a DVD disk or a USB memory) storing the program. In addition, for example, the program can be acquired by downloading the program from a server apparatus that manages a storage apparatus storing the program.

The computer 500 includes a bus 502, a processor 504, a memory 506, a storage device 508, an input/output interface 510, and a network interface 512. The bus 502 is a data transmission path through which the processor 504, the memory 506, the storage device 508, the input/output interface 510, and the network interface 512 transmit and receive data to and from one another. However, the method of connecting the processors 504 and the like to one another is not limited to bus connection.

The processor 504 is any of a variety of processors, such as a central processing unit (CPU), a graphics processing unit (GPU), or a field-programmable gate array (FPGA). The memory 506 is a main storage apparatus achieved by using a random access memory (RAM) or the like. The storage device 508 is an auxiliary storage apparatus achieved by using a hard disk, a solid state drive (SSD), a memory card, a read only memory (ROM), or the like.

The input/output interface 510 is an interface for connecting the computer 500 and an input/output device. For example, an input device such as a keyboard or an output device such as a display apparatus is connected to the input/output interface 510.

The network interface 512 is an interface for connecting the computer 500 to a network. The network may be a local area network (LAN) or a wide area network (WAN).

The storage device 508 stores a program (a program for executing the above-described application) for implementing each functional component of the control apparatus 2000. The processor 504 reads the program into the memory 506 and executes the program, thereby implements the respective functional components of the control apparatus 2000.

The control apparatus 2000 may be implemented by a single computer 500 or may be implemented by a plurality of computers 500. In the latter case, the configuration of each computer 500 need not be the same, but may be different.

### <Flow of Processing>

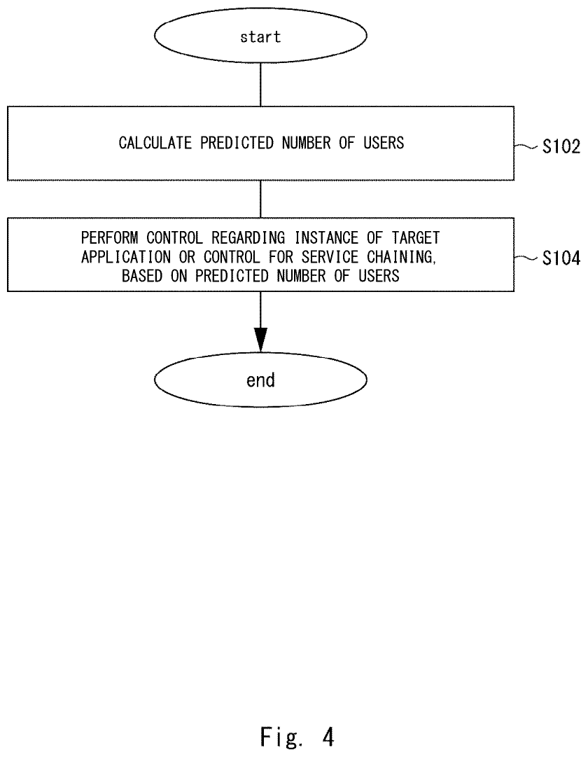

FIG. 4 is a flowchart illustrating a flow of processing executed by the control apparatus 2000 according to the first example embodiment. The prediction unit 2020 calculates the predicted number of users of the target service (S102). The control unit 2040 performs control regarding the instance of the target application or control for the service chaining among the target applications, based on the predicted number of users (S104).

The timing at which the control apparatus 2000 performs the above-described series of processes varies. For example, the control apparatus 2000 executes the series of processes in response to receiving a predetermined user input. In addition, for example, the control apparatus 2000 executes the series of processes at a predetermined timing. For example, the control apparatus 2000 executes the series of processes in response to reaching a predetermined time before (for example, 30 minutes or 1 hour before) a provision start date and time of the target service. In such a way, it becomes possible to appropriately set the instance of the target application and the service chaining among the target applications, before the provision of the target service is started.

### <Prediction of Number of Users of Target Service: S102>

The prediction unit 2020 predicts the number of users of the target service (S102). For example, the number of users of the target service is predicted based on the number of people who are predicted to visit the provision location of the target service. Hereinafter, a person who visits the provision location of the target service is referred to as a visitor, and the number of predicted visitors is referred to as the predicted number of visitors. In the above-described example of a video viewing service, in a case where the video viewing service is provided in a stadium, the audiences in the stadium are the visitors. Also, in a case where the video viewing service is provided at a public viewing venue, the participants of the public viewing are the visitors.

The prediction unit 2020 calculates the predicted number of visitors. The predicted number of visitors is predicted using, for example, information acquired from various apparatuses (such as Internet of things (IoT) devices) provided in the vicinity of the provision location of the target service. Hereinafter, some concrete methods are exemplified.

For example, the prediction unit 2020 acquires video data generated by a surveillance camera provided in the vicinity of the provision location of the target service (e.g., a surveillance camera provided within a predetermined distance from the provision location of the target service), and analyzes the video data to calculate the predicted number of visitors. For example, the ratio between the number of people detected from the video data and the number of visitors is set in advance, based on the past event results and the like. The prediction unit 2020 acquires video data generated after reaching a predetermined time before (for example, two hours or three hours before) the provision start date and time of the target service, and analyzes the video data to determine the number of people captured by the surveillance camera. The prediction unit 2020 uses a value acquired by multiplying the number of people captured by the surveillance camera by the above-described ratio as the predicted number of visitors.

In addition, for example, the prediction unit 2020 acquires usage record data indicating the usage record of the nearest station or the nearest bus terminal (hereinafter, the nearest station or the like) of the provision location of the target service, and analyzes the usage record data to calculate the predicted number of visitors. For example, the ratio between the number of users of the nearest station and the number of visitors is set in advance, based on the past event results and the like. The prediction unit 2020 acquires the usage record data after reaching a predetermined time before the provision start date and time of the target service, and analyzes the usage record data to identify the number of users of the nearest station or the like. The prediction unit 2020 uses a value acquired by multiplying the number of users of the nearest station or the like by the above-described ratio as the predicted number of visitors.

In addition, for example, it is assumed that a ticket needs to be purchased for using a part or all of a provision location of a target service. In such a case, the prediction unit 2020 may calculate the predicted number of visitors, based on the number of tickets sold. For example, the prediction unit 2020 uses the number of tickets sold as the predicted number of visitors as it is. In addition, for example, the ratio between the number of tickets sold and the number of visitors may be set in advance, based on the past event performance. In such a case, the prediction unit 2020 uses a value acquired by multiplying the number of tickets sold by the ratio as the predicted number of visitors. Note that information indicating the number of tickets sold can be acquired from, for example, a server of a system managing ticket sales.

The prediction unit 2020 calculates the predicted number of users (the predicted number of users of the target service) from the predicted number of visitors. For example, the ratio of the user of the target service to the total visitors is set in advance, based on past event results, results of prior questionnaires, and the like. In such a case, the prediction unit 2020 uses a value acquired by multiplying the predicted number of visitors by the ratio described above as the predicted number of users.

In addition, for example, the prediction unit 2020 may calculate the predicted number of visitors in consideration of the attribute of the predicted visitor in addition to the predicted number of visitors. As an attribute of the visitor, for example, an age group can be used. The attributes can be determined, for example, by analyzing above-described video data generated by the surveillance camera, usage records of nearest stations, and the like. In a case where video data is being used, the prediction unit 2020 classifies people detected from the video data by age group, and counts the number of people for each age group. As a result, the predicted number of visitors can be calculated for each age group. Note that an existing technique can be used as a technique for predicting the age of a person included in the video data.

Note that, the percentage of people using the target service may be different for each age group. For example, a video viewing service or the like using a mobile terminal is considered to be used more frequently by younger people than by the elderly. Therefore, for example, the ratio between the total number of visitors and the number of users of the target service is set for each age group. This ratio can be set based on, for example, a past usage record of the target service aggregated for each age group or a past usage record of the same type of service. In a case where the target service is the video viewing service described above, for example, the same type of service is a video distribution service or the like.

The prediction unit 2020 calculates, for each age group, the predicted number of users by multiplying the predicted number of visitors calculated for the age group by the ratio set for the age group. Then, the prediction unit 2020 calculates the total predicted number of users by adding up the predicted number of users calculated for each age group.

In a case where the predicted number of users is calculated for each attribute as described above, the attribute to be used is not limited to the age group, and various attributes related to the person can be used.

### <Control for Instances or Service Chaining: S104>

The control unit 2040 performs control regarding an instance of the target application or control for a service chaining among target applications (S104). Hereinafter, the control for the instance or the service chaining is concretely exemplified for each type of the control.

### <<Control of the Number of Instances>>

For example, the control unit 2040 determines the number of necessary instances (hereinafter, necessary number) for each target application, based on the number of users of the target service. Then, the control unit 2040 increases or decreases the instances of the target application in such a way that the number of instances matches the necessary number.

For example, for each target application, a relationship between the predicted number of users of the target service and the necessary number of instances of the target application is set in advance. This relationship can be generated by utilizing, for example, past event performance, simulation, or the like.

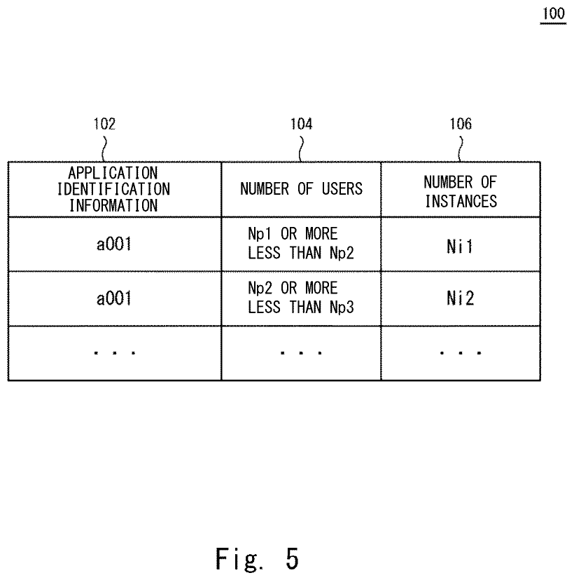

FIG. 5 is a diagram illustrating information in which the predicted number of users and the necessary number of instances are associated with each other. A table 100 in FIG. 5 associates three types of data: application identification information 102; the number of users 104; and the number of instances 106. The application identification information 102 indicates identification information (a name, an identifier, and the like) of the target application. The number of users 104 indicates a numerical range of the predicted number of users. The number of instances 106 indicates the necessary number of instances of the target application. For example, the record in the first row of the table 100 indicates that, for a target application named a001, when the predicted number of users is equal to or greater than Np1 and less than Np2, the necessary number of instances is Ni1.

In addition, for example, the control unit 2040 may calculate the amount of computer resources required for the target application by using the predicted number of users, and calculate the necessary number of instances of the target application by using the amount of computer resources required for the target application. In such a case, for example, the amount of computer resources that can be provided by one instance of the target application is set in advance. Then, the control unit 2040 calculates the necessary number of instances of the target application, based on the amount of computer resources required for the target application and the amount of computer resources that can be provided by one instance.

For example, for each target application, a relationship between the predicted number of users of the target service and the amount of computer resources required for the target application is set in advance. This relationship can be generated by utilizing, for example, past event performance, simulation, or the like. The control unit 2040 calculates the necessary amount of computer resources by utilizing the predicted number of users and the relationship.

Parameters other than the predicted number of users may be further taken into consideration in calculating the amount of computer resources required for the target application. Examples of such parameters include a date, a day of the week, a location where the target service is provided, a weather of a location where the target service is provided, a content of the target service, past performance data, a network usage amount, a physical network design, and the like. For example, in the case of the video viewing service described above, a prediction can be made in which the number of visitors decreases on a rainy day, and visitors concentrate on a stadium having a roof. In addition, for example, the amount of computer resources currently being used by the target application, the amount of computer resources currently being used by a physical machine on which the target application is running, and the like may be utilized as parameters being used for calculating the amount of computer resources required for the target application.

Therefore, for example, a calculation model (for example, a linear regression model) for calculating the amount of computer resources required for the target application from the predicted number of users and the values of various parameters described above is prepared in advance. The control unit 2040 uses the calculation model to calculate the amount of computer resources required for the target application. Note that, the calculation model can be generated through training utilizing past results, simulations, and the like.

The control unit 2040 controls the number of instances of each target application so that the number of instances becomes the necessary number calculated by the above-described method. Herein, there are various concrete methods for controlling the number of instances of an application. For example, the control unit 2040 transmits control information for instructing the number of instances to control software on the computer on which the target application is running. The control information indicates, for example, identification information of the target application and a necessary number of instances of the target application. In response to receiving the control information, the control software starts or stops the instance in such a way that the number of instances of the target application matches the necessary number indicated in the control information.

As a concrete method for starting and stopping an instance of an application, an existing method can be used. For example, it is assumed that an instance of the target application is executed on an instance of an execution environment such as a virtual machine or a container. In such a case, the number of instances of the target application can be increased or decreased by increasing or decreasing the number of instances of the execution environments (for example, the number of virtual machines or containers). However, a plurality of instances of the target application may run on one instance of the execution environment.

Note that the computer on which the instance of the target application runs may be the same as the computer on which the control apparatus 2000 operates. In other words, the control software that starts or stops the instance of the target application may run on the control apparatus 2000.

The transmission destination of the control information is not limited to the control software on the computer on which the instance of the target application runs. For example, it is assumed that a plurality of computers that are capable of operating an instance of a target application are provided. Hereinafter, such a group of computers is referred to as a cluster. Examples of an environment in which a cluster is prepared include a data center. In such an environment, a cluster control apparatus for controlling the cluster may be provided. The cluster control apparatus monitors the operation status (usage amount of each computer resources, the type of application in operation, and the like) of each computer constituting the cluster, and controls the arrangement of the instances of the application.

For example, the control unit 2040 transmits the above-described control information to the cluster control apparatus. In response to receiving the control information, the cluster control apparatus starts or stops the instance of the target application on the cluster so that the number of instances of the target application matches the necessary number indicated in the control information. In a case of starting an instance of an application, the cluster control apparatus selects, from the cluster, a computer on which an instance of the application is to be newly started, and starts an instance of the application on the selected computer. Meanwhile, in a case of stopping an instance of an application, the cluster control apparatus selects an instance to be stopped from among the instances of the application already running on the cluster. Then, the cluster control apparatus stops the selected instance.

It should be noted that an existing method can be used as a concrete method for determining a computer on which an instance of an application to be newly started or an instance of an application to be stopped, according to an operating state of each computer constituting the cluster.

The computer that implements the cluster control apparatus may be the same computer as the computer that implements the control apparatus 2000. That is, the control apparatus 2000 may have a function as a cluster control apparatus.

Herein, a plurality of clusters may be prepared at geographically distant locations (e.g., different data centers). In such a case, it is preferable that the control unit 2040 determines a cluster in which an instance of the target application is to be arranged in addition to the number of instances of the target application. In such a case, for example, the control unit 2040 acquires location information indicating a service provision location. Then, the control unit 2040 determines a cluster in which the instance of the target application is arranged, based on the service provision location indicated in the location information.

The cluster in which the instance of the target application is arranged is, for example, a cluster provided at a position closest to the service provision location. Herein, the index for measuring the proximity of the two locations may be a geographical distance between the locations (a distance in the real world), or may be a distance on a network connecting the locations (the number of hops or the like).

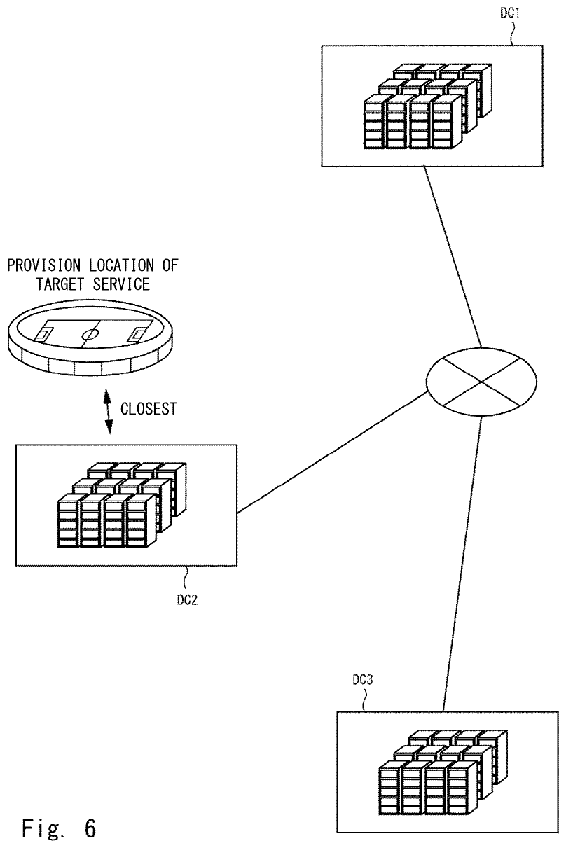

FIG. 6 is a diagram illustrating a plurality of clusters provided at locations apart from each other. In this example, three data centers, i.e., data centers DC1, DC2, and DC3, are provided. Each data center is provided with a cluster that can be used to provide a target service.

The control unit 2040 determines the cluster positioned closest to the service provision location as a cluster in which the target application is to be arranged. In this example, the cluster closest to the service provision location is installed in the data center DC2. Therefore, the control unit 2040 causes an instance of the target application to be arranged in the cluster provided in the data center DC2.

Herein, in a case where a plurality of clusters are provided at locations separated from each other as described above, an apparatus (hereinafter, referred to as a cluster group control apparatus) that controls the plurality of clusters may be provided. In such a case, for example, the control unit 2040 transmits, to the cluster group control apparatus, identification information of a cluster to be used, identification information of the target application, and the information indicating the necessary number of instances of the target application. The cluster group control apparatus further transmits, to a cluster control apparatus associated with the cluster indicated by the received information, identification information of the target application and information indicating the necessary number of instances of the target application. The cluster control apparatus that has received the information increases or decreases the instances of the target application, according to the necessary number of instances of the target application indicated in the information.

In the case where a plurality of clusters are provided as described above, the instance of the target application may be migrated instead of starting or stopping the instance of the target application. For example, in the case of FIG. 6, an instance of the target application can be increased by migrating an instance of the target application from a data center other than the data center DC2 to the data center DC2. Meanwhile, by migrating an instance of the target application from the data center DC2 to another data center, an instance of the target application can be reduced.

Herein, an existing technique can be used as a technique for migrating an instance of an application between clusters. For example, if an instance of an application is running on a virtual machine, the instance of the application can be migrated by migrating the virtual machine between clusters.

### <Control for Service Chaining: S104>

The control unit 2040 controls service chaining between target applications (S104). As described above, the control unit 2040 performs increasing, decreasing or arrangement changing of instances of each target application, according to the predicted number of users of the target service. Herein, in a case where the increase, the decrease, or the arrangement change of the target application is performed, it is necessary to appropriately connect a series of target applications connecting the source of data to be provided to the terminal of the user to the terminal in the network. In the video viewing service described above, for example, target applications and the like are connected on a network in order of a camera that generates video, an encoding server that encodes video data generated by the camera, a processing server that performs processes on the encoded video data, a distribution server that distributes the processed video data to a user's terminal, a security VNF interposed between the distribution server and the user's terminal, and a user's terminal that receives video data that has passed through the security VNF. The control unit 2040 performs appropriate connection (i.e., service chaining) of a series of target applications on the network, according to the increase, the decrease, or the change in the arrangement of the instances of the target application.

For example, service chaining according to the increase, the decrease, or the change in arrangement of an instance is performed based on a predetermined rule. Herein, an existing technique can be used as a concrete method for performing service chaining based on the predetermined rule. As a rule of service chaining in the video viewing service described above, for example, the following rule can be considered. First, a video processing server is provided between the encoding server and the distribution server. In addition, load balancing VNFs are provided between various servers. If the user adds a security service, a security VNF is additionally provided. Then, a user terminal, the security VNF, the video processing server, and the distribution server are chained in this order in such a way that comments can be added to the video via the security VNF.

Although the present invention has been described with reference to the example embodiments, the present invention is not limited to the above-described example embodiments. Various modifications that can be understood by a person skilled in the art within the scope of the present invention can be made to the configuration and details of the present invention.

In the above-described example, the program includes instructions (or software codes) for causing a computer to execute one or more of the functions described in the example embodiments when the program is loaded onto the computer. The program may be stored in a non-transitory computer-readable medium or a tangible storage medium. By way of example, and not limitation, computer-readable media or tangible storage media include a random-access memory (RAM), a read-only memory (ROM), a flash memory, a solid-state drive (SSD), or other memory technologies, a CD-ROM, a digital versatile disc (DVD), a Blu-ray (registered trade mark) disk, or other optical disk storages, a magnetic cassette, a magnetic tape, a magnetic disk storage, or other magnetic storage devices. The program may be transmitted on a transitory computer-readable medium or a communication medium. By way of example, and not limitation, the transitory computer-readable media or communication media include an electrical, optical, acoustic, or other forms of propagated signals.

Some or all of the above-described example embodiments may be described as the following supplementary notes, but are not limited thereto.

### (Supplementary Note 1)

A control apparatus including:
a prediction unit configured to predict the number of users of a service to be provided at a specific location, before the provision of the service starts; and a control unit configured to perform control regarding an instance of an application providing the service or control for a service chaining among a plurality of the applications, based on the predicted number of users.

### (Supplementary Note 2)

The control apparatus according to supplementary note 1, wherein the prediction unit predicts the number of visitors being people who come to the specific location, and predicts the number of users of the service from the predicted number of visitors.

### (Supplementary Note 3)

The control apparatus according to supplementary note 1 or 2, wherein the control unit calculates the number of the instances necessary for providing the service, based on the predicted number of users, and increases or decreases the number of the instances in such a way that the number of the instances becomes the calculated number.

### (Supplementary Note 4)

The control apparatus according to supplementary note 3, wherein the control unit
calculates an amount of computer resources necessary for providing the service, based on the predicted number of users, and
calculates the number of the instances necessary for allocating the calculated amount of computer resources to the application as the number of the instances necessary for providing the service.

### (Supplementary Note 5)

The control apparatus according to any one of supplementary notes 1 to 4, wherein the control unit determines a cluster for operating the instance from among a plurality of clusters being capable of operating the instance, based on a position of the specific location and a position of each of a plurality of the clusters.

### (Supplementary Note 6)

A control method to be executed by a computer, the method including:
a prediction step of predicting the number of users of a service to be provided at a specific location, before the provision of the service starts; and
a control step of performing control regarding an instance of an application providing the service or control for a service chaining among a plurality of the applications, based on the predicted number of users.

### (Supplementary Note 7)

The control method according to supplementary note 6, wherein the predicting step further includes predicting the number of visitors being people who come to the specific location, and predicting the number of users of the service from the predicted number of visitors.

### (Supplementary Note 8)

The control method according to supplementary note 6 or 7, wherein the control step further includes calculating the number of the instances necessary for providing the service, based on the predicted number of users, and increasing or decreasing the number of the instances in such a way that the number of the instances becomes the calculated number.

### (Supplementary Note 9)

The control method according to supplementary note 8, wherein the control step further includes
calculating an amount of computer resources necessary for providing the service, based on the predicted number of users, and
calculating the number of the instances necessary for allocating the calculated amount of computer resources to the application as the number of the instances necessary for providing the service.

### (Supplementary Note 10)

The control method according to any one of supplementary notes 6 to 9, wherein the control step further includes determining a cluster for operating the instance from among a plurality of clusters being capable of operating the instance, based on a position of the specific location and a position of each of a plurality of the clusters.

### (Supplementary Note 11)

A non-transitory computer-readable medium storing a program that causes a computer to execute:
a prediction step of predicting the number of users of a service to be provided at a specific location, before the provision of the service starts; and
a control step of performing control regarding an instance of an application providing the service or control for a service chaining among a plurality of the applications, based on the predicted number of users.

### (Supplementary Note 12)

The computer-readable medium according to supplementary note 11, wherein the prediction step further includes predicting the number of visitors being people who come to the specific location, and predicting the number of users of the service from the predicted number of visitors.

### (Supplementary Note 13)

The computer-readable medium according to supplementary note 11 or 12, wherein the control step further includes calculating the number of the instances necessary for providing the service, based on the predicted number of users, and increasing or decreasing the number of the instances in such a way that the number of the instances becomes the calculated number.

### (Supplementary Note 14)

The computer-readable medium according to supplementary note 13, wherein the control step further includes
calculating an amount of computer resources necessary for providing the service, based on the predicted number of users, and
calculating the number of the instances necessary for allocating the calculated amount of computer resources to the application as the number of the instances necessary for providing the service.

### (Supplementary Note 15)

The computer-readable medium according to any one of supplementary notes 11 to 14, wherein the control step further includes determining a cluster for operating the instance from among a plurality of clusters being capable of operating the instance, based on a position of the specific location and a position of each of a plurality of the clusters.

### REFERENCE SIGNS LIST

100 TABLE
102 APPLICATION IDENTIFICATION INFORMATION
104 NUMBER OF USERS
106 NUMBER OF INSTANCES
500 COMPUTER
502 BUS
504 PROCESSOR
506 MEMORY
508 STORAGE DEVICE
510 INPUT/OUTPUT INTERFACE
512 NETWORK INTERFACE
2000 CONTROL APPARATUS
2020 PREDICTION UNIT
2040 CONTROL UNIT
DC1, DC2, DC3 DATA CENTER

What is claimed is:

1. A control apparatus comprising:
at least one memory that is configured to store instructions; and
at least one processor that is configured to execute the instructions to:
predict the number of users of a service to be provided at a specific location, before the provision of the service starts; and
perform control regarding an instance of an application providing the service or control for a service chaining among a plurality of the applications, based on the predicted number of users.

2. The control apparatus according to claim 1,
wherein the prediction of the number of users of the service further includes predicting the number of visitors that are people who visit the specific location, and predicting the number of users of the service from the predicted number of visitors.

3. The control apparatus according to claim 1,
wherein the control regarding the instance includes calculating the number of the instances necessary for providing the service based on the predicted number of users, and increasing or decreasing the number of the instances so that the number of the instances becomes the calculated number.

4. The control apparatus according to claim 3,
wherein the control regarding the instance includes:
calculating an amount of computer resources necessary for providing the service based on the predicted number of users; and
calculating the number of the instances necessary for allocating the calculated amount of computer resources to the application, as the number of the instances necessary for providing the service.

5. The control apparatus according to claim 1,
wherein the control regarding the instance includes determining, based on a position of the specific location and a position of each of a plurality of clusters being capable of operating the instance, the cluster for operating the instance from among a plurality of the clusters.

6. A control method to be executed by a computer, the method comprising:
predicting the number of users of a service to be provided at a specific location, before the provision of the service starts; and
performing control regarding an instance of an application providing the service or control for a service chaining among a plurality of the applications, based on the predicted number of users.

7. The control method according to claim 6,
wherein the prediction of the number of users of the service further includes predicting the number of visitors that are people who visit the specific location, and predicting the number of users of the service from the predicted number of visitors.

8. The control method according to claim 6,
wherein the control regarding the instance further includes calculating the number of the instances necessary for providing the service, based on the predicted number of users, and increasing or decreasing the number of the instances so that the number of the instances becomes the calculated number.

9. The control method according to claim 8,
wherein the control regarding the instance further includes:
calculating an amount of computer resources necessary for providing the service, based on the predicted number of users; and
calculating the number of the instances necessary for allocating the calculated amount of computer resources to the application as the number of the instances necessary for providing the service.

10. The control method according to claim 6,
wherein the control regarding the instance further includes determining, based on a position of the specific location and a position of each of a plurality of clusters being capable of operating the instance, the cluster for operating the instance from among a plurality of the clusters.

11. A non-transitory computer-readable medium storing a program that causes a computer to execute:
predicting the number of users of a service to be provided at a specific location, before the provision of the service starts; and
performing control regarding an instance of an application providing the service or control for a service chaining among a plurality of the applications, based on the predicted number of users.

12. The computer-readable medium according to claim 11,
wherein the prediction of the number of users of the service further includes predicting the number of visitors that are people who visit the specific location, and predicting the number of users of the service from the predicted number of visitors.

13. The computer-readable medium according to claim 11,
wherein the control regarding the instance further includes calculating the number of the instances necessary for providing the service, based on the predicted number of users, and increasing or decreasing the number of the instances so that the number of the instances becomes the calculated number.

14. The computer-readable medium according to claim 13,
wherein the control regarding the instance further includes
calculating an amount of computer resources necessary for providing the service, based on the predicted number of users; and
calculating the number of the instances necessary for allocating the calculated amount of computer resources to the application as the number of the instances necessary for providing the service.

15. The computer-readable medium according to claim 11,
wherein the control regarding the instance further includes determining, based on a position of the specific location and a position of each of a plurality of clusters being capable of operating the instance, the cluster for operating the instance from among a plurality of the clusters.
